(19) United States
(12) Patent Application Publication
(10) Pub. No.: US 2010/0325255 A1
(43) Pub. Date: Dec. 23, 2010

(54) DATA TRANSMISSION SYSTEM AND METHOD

(76) Inventors: Gene Cheung, Tokyo (JP); Takashi Sakamoto, Tokyo (JP)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/594,800

(22) PCT Filed: Apr. 5, 2007
(86) PCT No.: PCT/JP2008/056091

§ 371 Date: Mar. 4, 2010

(30) Foreign Application Priority Data
Apr. 5, 2007 (JP) 2007-099016

(51) Int. Cl. G06F 15/173

(52) U.S. Cl. 709/223

(57) ABSTRACT

There is provided a data transmission system capable of preferably transmitting data, the real-time property of which is regarded as being important and which is generated at a short period of time, over a network that causes delay and the missing of transmission data. An avatar location processing unit (202) periodically generates, according to the user operation, location update information (x[n]) indicating a location of a character (avatar) of a network game in a virtual space. A location estimation information creating unit (208) generates location estimation location information (y[m]) for estimating, from the location update information (x[n]), the avatar location at a previous period. The location update information (x[n]) and the location estimation location information (y[m]) are sent from a game server side (2) to a game client computer side (3) and the missing of the location update information (x [n]) is restored or estimated to display the avatar.

### TECHNICAL FIELD

The present invention relates to a data transmission system in which transmission data generated periodically is transmitted and a method therefor.

### BACKGROUND ART

A network game system in which a large number of users of client computers are connected to a game server computer via a network to enjoy a game in a real-time manner is in operation.

Examples of such a network game may include a first person shooting game in which a person's image (avatar) used by a user (player) within a game is free to move within a virtual world of the game and fights an encountered avatar of another player or plays gun shooting with the encountered avatar in a real-time manner according to the player's operation.

In such a network game, all of avatars that exist within a range that can be displayed must be displayed on each of client computers.

In order to realize such a network game as described above, a position and the like of an avatar in a game virtual world need to be transmitted between the client computers and a game server via a network that causes a delay and a loss of transmission data in short cycles in a real-time manner.
Non-Patent Document 1: “bzflag,” http://wwsv.bzffag.org.
Non-Patent Document 2: “sauerbraten,” http://sauerbraten.org.
Non-Patent Document 3: G. Arrnitage, M. Claypool, and P. Branch, Networking and Online Games: Understanding and Engineering Multiplayer Internet Games, John Wiley and Sons Ltd, 2006.
Non-Patent Document 4: L. Pantel and L. Wolf, “On the suitability of dead reckoning schemes for games:’ in ACM SIGCOMM NetGames, Braunschweig, Germany, April 2002.
Non-Patent Document 5: S Aggarwal H Banavar and A Khandelwal “Accuracy in dead-reckoning based distributed multi-player games:’ in ACM SIGCOMM NetGames, Portland, Oreg., August 2004.
Non-Patent Document 6: M. Mauve, “How to keep a dead man from shooting,” in Interactive Distributed Multimedia Systems and Telecommunication Services, 2000, pp. 199-204.
Non-Patent Document 7: W. Press, S. Teukolsky, W. Vetterling, and B. Flaunery, Eds., Numerical Recipes in C++. Cambridge University Press, 2002.
Non-Patent Document 8: M. Hayes, Statistical Digital Signal Processing and Modeling, John Wiley and Son Ltd, 2005.

### DISCLOSURE OF THE INVENTION

### Problem to be Solved by the Invention

The present invention has been made against such a backdrop as described above, and therefore an object thereof is to provide: a data transmission system improved for transmitting data, whose real-time property is regarded as being important and which is generated periodically, via a network that causes a delay and a loss of transmission data; and a method therefor.

### Means for Solving the Problem

In order to achieve the above-mentioned object, a data transmission system according to the present invention is a data transmission system for transmitting transmission data generated in each of predetermined cycles and prediction data for predicting transmission data in a cycle subsequent thereto based on one or more items of the transmission data from a transmission device to a reception device via a network, the network causing a delay and a loss with respect to the transmission data, the transmission device including: transmission data generation means for generating the transmission data; prediction data generation means for generating the prediction data; and transmission means for transmitting the generated transmission data and transmitting the generated prediction data by using a bandwidth of a difference between a bandwidth allocated on the network and a bandwidth of the transmission data, the reception device including: reception means for receiving the transmission data and the prediction data that have been transmitted; and reconstruction/estimation means for reconstructing or estimating, when the transmission data is lost, the lost transmission data by using the transmission data and the prediction data that have been received.

Preferably, the reception device further includes a delay compensation means for compensating for the delay that has occurred in the transmission data in the network.

Preferably, the transmission device further includes transmittability judgment means for judging whether or not the prediction data is transmittable based on the difference between the bandwidth allocated on the network and the bandwidth of the transmission data and the bandwidth necessary for transmitting the generated prediction data, and the transmission means transmits the prediction data if the prediction data is judged to be transmittable.

Preferably, the transmittability judgment means judges whether or not the prediction data is transmittable based on a token bucket scheme so as to prevent, even if the prediction data is transmitted, the bandwidth of the transmitted prediction data from exceeding the difference between the bandwidth allocated on the network and the bandwidth of the transmission data.

Preferably, the transmission device further includes transmission time judgment means for judging whether or not a time difference from transmission of the transmission data until transmission of the prediction data used for prediction using the transmission data is shorter than a predetermined threshold value (Δ), and the transmission means transmits the prediction data if the time difference until the transmission of the prediction data is shorter than the predetermined threshold value.

Preferably, the reception device further includes reception time judgment means for judging whether or not the transmission data in the subsequent cycle has been received by a time difference within a predetermined threshold value (f) from reception of the transmission data, and the estimation means estimates transmission data subsequent to the received transmission data if the transmission data in the subsequent cycle has not been received by the time difference within the predetermined threshold value.

Preferably, the reception device further includes forecast means for forecasting transmission data to be received in a future based on the received transmission data and the estimated transmission data or any one thereof.

Preferably, the transmission data indicates a position of a moving object in the each of the predetermined cycles.

The transmission data indicates, in a network game performed by moving one or more avatars, a position of each of the one or more avatars in the each of the predetermined cycles.

Further, a data transmission method according to the present invention is a data transmission method of transmitting transmission data generated in each of predetermined cycles and prediction data for predicting transmission data in a cycle subsequent thereto based on one or more items of the transmission data from a transmission device to a reception device via a network, the network causing a delay and a loss with respect to the transmission data, the data transmission method including: by the transmission device: generating the transmission data; generating the prediction data; and transmitting the generated transmission data and transmitting the generated prediction data by using a bandwidth of a difference between a bandwidth allocated on the network and a bandwidth of the transmission data; and by the reception device: receiving the transmission data and the prediction data that have been transmitted; and reconstructing or estimating, when the transmission data is lost, the lost transmission data by using the transmission data and the prediction data that have been received.

Further, a data transmission program according to the present invention is a data transmission program for transmitting transmission data generated in each of predetermined cycles and prediction data for predicting transmission data in a cycle subsequent thereto based on one or more items of the transmission data from a transmission device to a reception device via a network, the network causing a delay and a loss with respect to the transmission data, the data transmission program causing a computer to execute, in the transmission device: a transmission data generation step of generating the transmission data; a prediction data generation step of generating the prediction data; and a transmission step of transmitting the generated transmission data and transmitting the generated prediction data by using a bandwidth of a difference between a bandwidth allocated on the network and a bandwidth of the transmission data, the data transmission program further causing the computer to execute, in the reception device: a reception step of receiving the transmission data and the prediction data that have been transmitted; and a reconstruction/estimation step of reconstructing or estimating, when the transmission data is lost, the lost transmission data by using the transmission data and the prediction data that have been received.

### Effect of the Invention

According to the data transmission system and the method therefor according to the present invention, it is possible to satisfactorily transmit the data, whose real-time property is regarded as being important and which is generated periodically, via the network that causes the delay and the loss of the transmission data.

### BRIEF DESCRIPTION OF THE DRAWINGS

FIG. 1 is a diagram exemplifying a configuration of a network game system to which a data transmission method according to the present invention is applied.

FIG. 2 is a diagram exemplifying hardware configurations of a game server and a game client computer that are illustrated in FIG. 1.

FIG. 3 is a diagram illustrating software configurations of server software and client software that are executed on the game server and the game client computer, respectively, that are illustrated in FIGS. 1 and 2.

FIG. 4 is a diagram exemplifying avatars of respective players, which move in a virtual space of a network game.

FIG. 5 is a diagram illustrating a position prediction information item y[m] formed by a position prediction information formation unit illustrated in FIG. 3.

FIG. 6 are diagrams exemplifying a function of a position prediction information item y[n+1], in which: FIG. 6(A) illustrates the function of a position prediction information item y[4] at a time when a position update information item x[3] among the position update information items x[1] to x[3] is lost; FIG. 6(B) illustrates the function of the position prediction information item y[4] at a time when the position update information item x[2] is lost; FIG. 6(C) illustrates the function of the position prediction information item y[4] at a time when the position update information items x[2] and x[3] are lost; and FIG. 6(D) illustrates the function of the position prediction information item y[4] at a time when a position update information item x[4] is lost.

FIG. 7 is a diagram illustrating a relationship between a transmittable band B of a network and a band R used for transmission of a position update information item x[n].

FIG. 8 is a diagram illustrating transmission control for the position prediction information item y[m] based on a token bucket scheme, which is performed by a token control unit illustrated in FIG. 3.

FIG. 9 is a diagram exemplifying the transmission control for the position prediction information item y[m], which is performed by a delay control unit illustrated in FIG. 3.

FIG. 10 is a diagram exemplifying a relationship between a threshold value used for the transmission control for the position prediction information item y[m] illustrated in FIG. 9 and a distortion (here, difference between an actual position and a predicted position).

FIG. 11 is a diagram exemplifying the above-mentioned relationship between a waiting time threshold value δ and the distortion (difference between the actual position and the predicted position).

### BEST MODE FOR CARRYING OUT THE INVENTION

[Network Game System 1]

Hereinafter, description is made of an embodiment of the present invention.

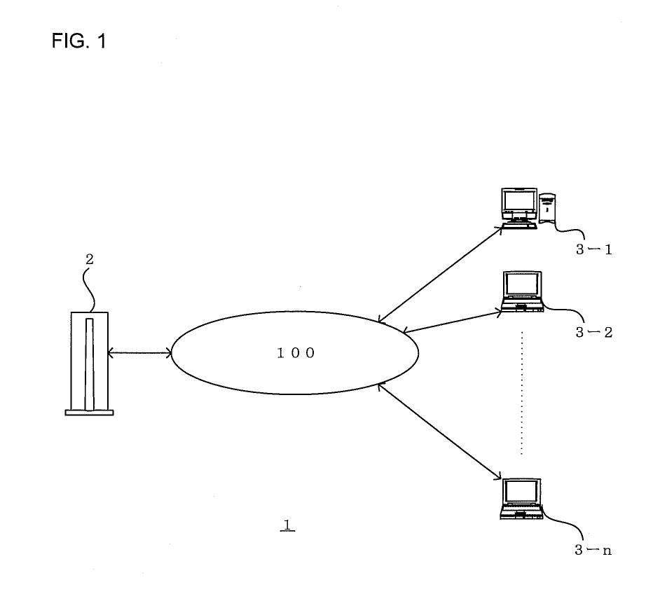

FIG. 1 is a diagram exemplifying a configuration of a network game system 1 to which a data transmission method according to the present invention is applied.

As illustrated in FIG. 1, the network game system 1 is configured by one or more game servers 2 and a plurality of game client computers 3-1 to 3-n (n≧2) which are connected to one another via a network 100 such as the Internet.

Note that hereinbelow, in the respective drawings, substantially the same components are denoted by the same reference symbol, and any one of the game client computers 3-1 to 3-n or a plurality of other such components is referred to merely as a game client computer 3 when indicated without being identified.

Further, the game server 2 and the game client computer 3 may be each referred to generically as a node.

[Hardware Configuration]

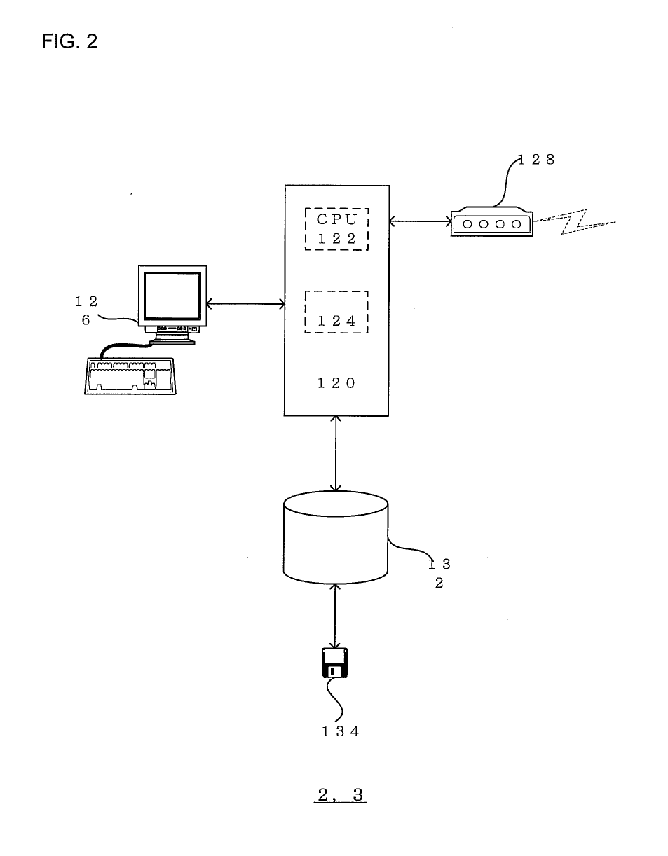

FIG. 2 is a diagram exemplifying hardware configurations of the game server 2 and the game client computer 3 that are illustrated in FIG. 1.

As illustrated in FIG. 2, the game server 2 and the game client computer 3 are each configured by a system core 120 including a CPU 122 and a memory 124, an input/output device 126 including a display device and a keyboard, a communication device 128 that performs communications with another node, and a storage device 132 such as a CD device and an HDD device.

That is, the game server 2 and the game client computer 3 each has hardware resources serving as a computer that can communicate with another node via the network 100.

[Software Configuration]

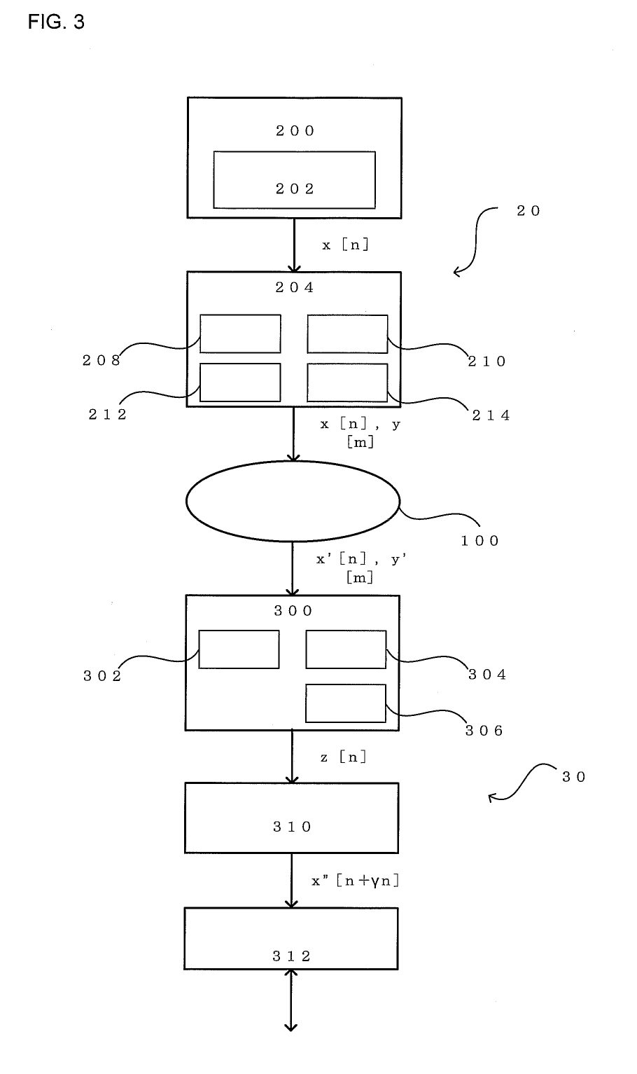

FIG. 3 is a diagram illustrating software configurations of server software 20 and client software 30 that are executed on the game server 2 and the game client computer 3, respectively, that are illustrated in FIGS. 1 and 2.

The server software 20 and the client software 30 are, for example, supplied to the game server 2 and the game client computer 3 via a storage medium 134 (FIG. 2), loaded onto the network game system 124, and executed by specifically using the hardware resources of the game server 2 and the game client computer 3 via an OS (not shown).

Note that in FIG. 3, a case where a position of an avatar of each player is transmitted from the game server 2 to the game client computer 3 is exemplified, and the other components are omitted.

As illustrated in FIG. 3, the server software 20 is configured by server-side game software 200 and server-side interface (IF) software 204.

The server-side game software 200 includes an avatar position processing unit 202.

The server-side interface software 204 includes a position prediction information formation unit 208, a transmission unit 210, a token control unit 212, and a delay control unit 214.

The client software 30 is configured by client-side interface software 300, dead-reckoning processing software 310, and client-side game software 312.

The client-side interface software 300 includes a delay control unit 302, a reception unit 304, and a reconstruction/estimation unit 306.

By those components, the server software 20 and the client software 30 receive the player's operation with respect to the game client computer 3, and cause the input/output device 126 (FIG. 2) of the game client computer 3 to display the avatar of each player so as to move in a real-time manner.

That is, the server software 20 and the client software 30 provide the player with a function for making progress in a network game such as a first person shooting game, in which a real-time property is regarded as being important.

[Server Software 20]

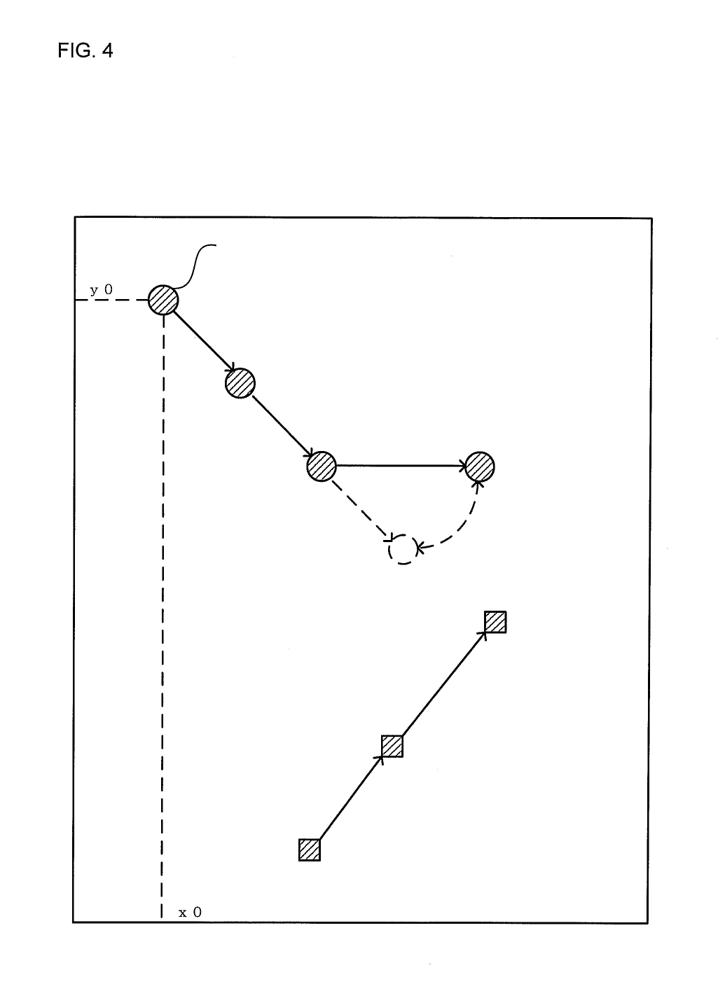

FIG. 4 is a diagram exemplifying the avatars of the respective players, which move in a virtual space of the network game.

The server-side game software 200 causes the network game to make progress according to an operation performed by the player of the game client computer 3.

In the server-side game software 200, the avatar position processing unit 202 forms a position update information item x[n] that indicates a position of each user's avatar in the virtual space of the network game every constant cycle T (for example, every 1/10 seconds), and outputs the position update information item x[n] to the server-side interface software 204.

[Server-Side Interface Software 204]

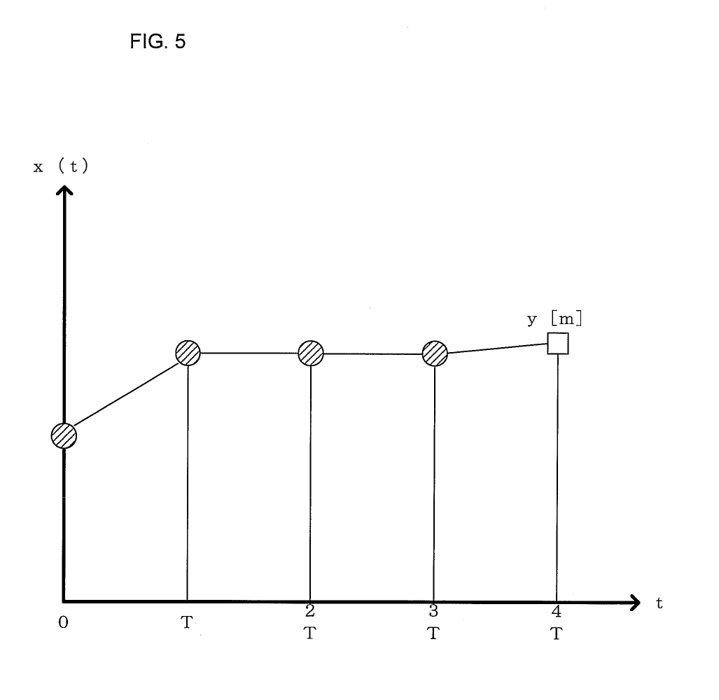

FIG. 5 is a diagram illustrating a position prediction information item y[m] formed by the position prediction information formation unit 208 illustrated in FIG. 3.

In the server-side interface software 204, based on the position update information items x[n] as illustrated by the shaded circles in FIG. 5, which are input from the avatar position processing unit 202 and which indicate the positions of the avatar at respective time points (0 to 3T), the position prediction information formation unit 208 forms a position prediction information item y[n+1] that predicts and indicates the position of the avatar at the subsequent time point (T4) as illustrated by the white circle in FIG. 5.

A relationship between the position prediction information item y[n+1] at the subsequent time point and the position update information items x[n], x[n−1], . . . , and x[n−k] (k≧1) until that time point can be expressed as follows:

y[n+1]=f(x[n], x[n−1], . . . , x[n−k])

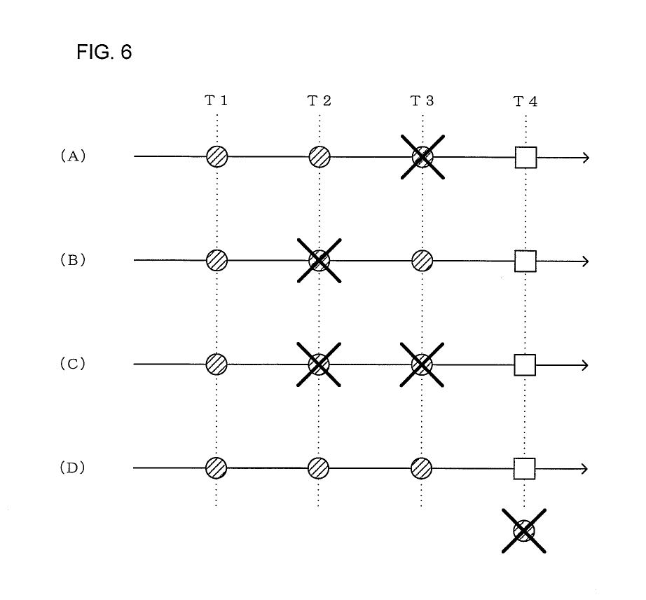

FIG. 6 are diagrams exemplifying a function of the position prediction information item y[n+1], in which: FIG. 6(A) illustrates the function of a position prediction information item y[4] at a time when a position update information item x[3] among the position update information items x[1] to x[3] is lost; FIG. 6(B) illustrates the function of the position prediction information item y[4] at a time when the position update information item x[2] is lost; FIG. 6(C) illustrates the function of the position prediction information item y[4] at a time when the position update information items x[2] and x[3] are lost; and FIG. 6(D) illustrates the function of the position prediction information item y[4] at a time when a position update information item x[4] is lost.

As illustrated in FIGS. 6(A) to 6(D), the position prediction information item y[n+1] has the following functions (1) to (3).

The position prediction information item y[n+1] has the following functions (1) to (3).

(Function 1) As illustrated in FIGS. 6(A) and 6(B), when any one of the position update information items x[n], x[n−1], . . . , and x[n−k] is lost in the network 100, the position prediction information item y[n+1] is used as a parity that can completely reconstruct the lost position update information item.

(Function 2) As illustrated in FIG. 6(C), when any two of the position update information items x[n], x[n−1], . . . , and x[n−k] or more are lost in the network 100, the position prediction information item y[n+1] is used to predict the lost position update information items.

(Function 3) As illustrated in FIG. 6(D), when a position update information item x[n+1] is lost in the network 100 after the position prediction information item y[n+1] is generated, the position prediction information item y[n+1] can be used as a predicted value for the position update information item x[n+1].

In order to obtain the position prediction information item y[n+1], the following methods (1) to (4) are available.

The position prediction information formation unit 208 uses any one of the following methods (1) to (4) to obtain the position prediction information item y[m].

(Method 1) 0^{th}-Order Hold:

The position update information item x[n] is set as the position prediction information item y[n+1] (y[n+1]=x[n]) per se.

According to this method, if the position update information item x[n] is lost in the network 100, it is possible based on the position prediction information item y[n+1] to completely reconstruct the position update information item x[n].

In addition, when a burst error occurs in the network 100 and when the position update information items x[n], x[n−1], . . . , and x[n−k] are lost, it is possible based on the position prediction information item y[n+1] and the position update information item x[n−k−1] to extrapolate the position update information items x[n], x[n−1], . . . , and x[n−k].

Further, when the position update information item x[n+1] is lost in the network 100, it is possible based on the position prediction information item y[n+1] to predict the position update information item x[n+1].

(Method 2) Linear Extrapolation:

The position prediction information item y[n+1] is obtained by using the two position update information items x[n] and x[n−1].

When the position update information items x[n] and x[n−1] are obtained at time points nT and (n−1)T (=tₙ and tₙ₋₁), respectively, and it is assumed that the items x[n] and x[n−1] are represented as xₙ and xₙ₋₁, the position prediction information item y(t) at the time point t can be obtained by:

y(t)=Axₙ₋₁+Bxₙ,

A=(tₙ−t)/(tₙ−tₙ₋₁),

B=1−A=(t−tₙ₋₁)/(tₙ−tₙ₋₁)

According to this method, if the item x[n] or x[n−1] is lost, it is possible to completely reconstruct the item x[n] or x[n−1] that has been lost by using the item y[n+1] and the item x[n] or x[n−1] that has arrived.

However, if the items x[n] and x[n−1] are both lost, those items cannot be reconstructed completely.

In addition, when a burst error occurs in the network 100 and when the position update information items x[n], x[n−1], . . . , and x[n−k] are lost, it is possible based on the position prediction information item y[n+1] and the position update information item x[n−k−1] to extrapolate the position update information items x[n], x[n−1], . . . , and x[n−k].

In addition, when the position update information item x[n+1] is lost in the network 100, it is possible based on the position prediction information item y[n+1] to predict the position update information item x[n+1].

(Method 3) Cubic Spline Extrapolation:

In order to obtain the position prediction information item y(t) by smoothing a curve drawn by the position prediction information item y(t) obtained by extrapolation, the following expression is used.

y(t)=Axₙ₋₁+Bxₙ+Cx″ₙ₋₁+Dx″ₙ,

where x″ₙ₋₁ and x″ₙ are second-order derivatives in tₙ₋₁ and tₙ of y(t) and the following are satisfied:

C=(⅙)(A³−A)(tₙ−tₙ₋₁)²,

D=(⅙)(B³−B)(tₙ−tₙ₋₁)²

(Method 4) Linear Prediction:

The position prediction information item y[n+1] can be obtained by the following Expression 1.

$$y [ n + 1 ] = {f}^{T} x , f = [ \begin{matrix}{f}_{M} \\ ⋮ \\ {f}_{1}\end{matrix} ] , x = [ \begin{matrix}x [ n ] \\ ⋮ \\ x [ n - m + 1 ]\end{matrix} ] \qquad [ Expression 1 ]$$

In Expression 1, f is obtained by solving ATAf=Ad with A and d assumed as in the following Expression 2, and is obtained by f=A+d when it is assumed that a pseudo inverse matrix of A is A+ (see Non-Patent Document 8, in which details thereof are described)

$$A = [ \begin{matrix}x [ m ] & ⋯ & x [ 1 ] \\ x [ m + 1 ] & ⋯ & x [ 2 ] \\ ⋮ & & ⋮ \\ x [ n - 1 ] & ⋯ & x [ n - m ]\end{matrix} ] , d = [ \begin{matrix}x [ m + 1 ] \\ ⋮ \\ x [ n ]\end{matrix} ] \qquad [ Expression 2 ]$$

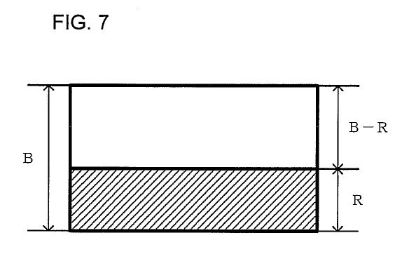

FIG. 7 is a diagram illustrating a relationship between a transmittable band B of the network 100 and a band R used for transmission of the position update information item x[n].

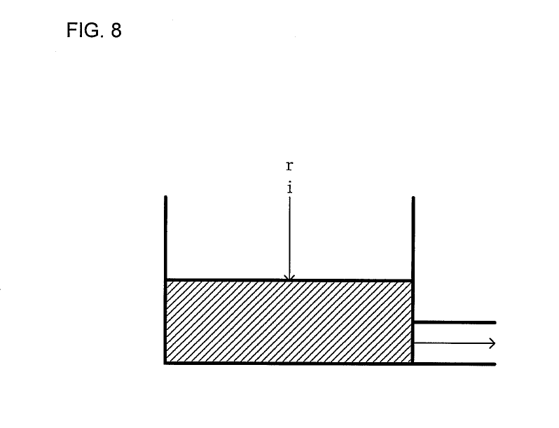

FIG. 8 is a diagram illustrating transmission control for the position prediction information item y[m] based on a token bucket scheme, which is performed by the token control unit 212 illustrated in FIG. 3.

As illustrated in FIG. 7, the transmittable band B of the network 100 has enough room for the band R (R<B) used for the transmission of the position update information item x[n].

By using a band B−R remaining after the transmission of the position update information item x[n] via the network 100, which is illustrated in FIG. 7, the token control unit 212 controls the transmission unit 210 to cause the network 100 to transmit the position prediction information item y[m] via the network 100.

The transmission of the position prediction information item y[m] via the network 100 is given a condition that a band used for the transmission of the position prediction information item y[m] must be smaller than B−R.

As illustrated in FIG. 8, there is provided a token bucket, into which tokens of ri(bps)=B−R are caused to continuously flow.

Normally, the token bucket is realized in a software manner, and hence hardware that directly corresponds thereto does not need to exist.

When an amount of tokens accumulated and in token bucket reaches a data amount of the position prediction information item y[m] formed by the position prediction information formation unit 208, the token control unit 212 judges that the position prediction information item y[m] is transmittable, clears the token bucket, and controls the transmission unit 210 so as to transmit the position prediction information item y[m].

As apparent from the above-mentioned description, a capacity of the token bucket may be regarded as being the same in principle as the data amount of the position prediction information item y[m].

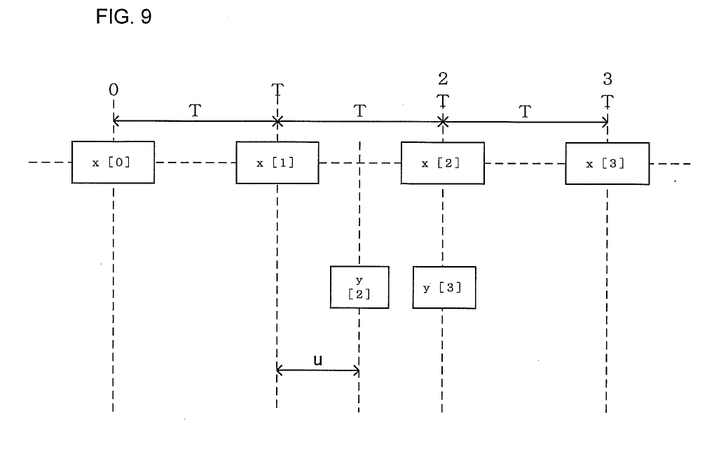

FIG. 9 is a diagram exemplifying the transmission control for the position prediction information item y[m], which is performed by the delay control unit 214 illustrated in FIG. 3.

As illustrated in FIG. 9, the position update information item x[n] is transmitted from the game server 2 to the game client computer 3 at intervals of T (seconds).

For example, the token control unit 212 judges that a position prediction information item y[2] obtained based on position update information items x[0] and x[1] is transmittable at a time point T+u, i.e., u (u<T) seconds after the position update information item x[1] is transmitted.

However, in a case where the time offset u from the last position update information transmission time point is close enough to T, that is, immediately before the subsequent position update information transmission time point (2T), it is more advantageous to transmit a position prediction information item y[3] after waiting until the subsequent position update information item x[2] is transmitted at the time point 2T than to immediately transmit the position prediction information item y[2].

The reason therefor is that it is possible to transmit the position prediction information item y[3], which is information on a position at the subsequent stage, with a slight increase of waiting time instead of immediately transmitting the position prediction information item y[2], which is soon to become obsolete, and hence it is possible to make effective use of an available band.

After the transmission of the position update information item x[n], the delay control unit 214 compares the time offset u until the token control unit 212 judges that the position prediction information item y[n+1] is transmittable with a threshold value Δ, and if the time offset u is smaller than the threshold value Δ, transmits the formed position prediction information item y[n+1]. If the time offset u is equal to or larger than the threshold value Δ, the delay control unit 214 controls the transmission unit 210 so as to wait until a timing for the subsequent transmission of the position update information item x[n+1] before transmitting the item x[n+1] first and then transmitting the position prediction information item y[n+2].

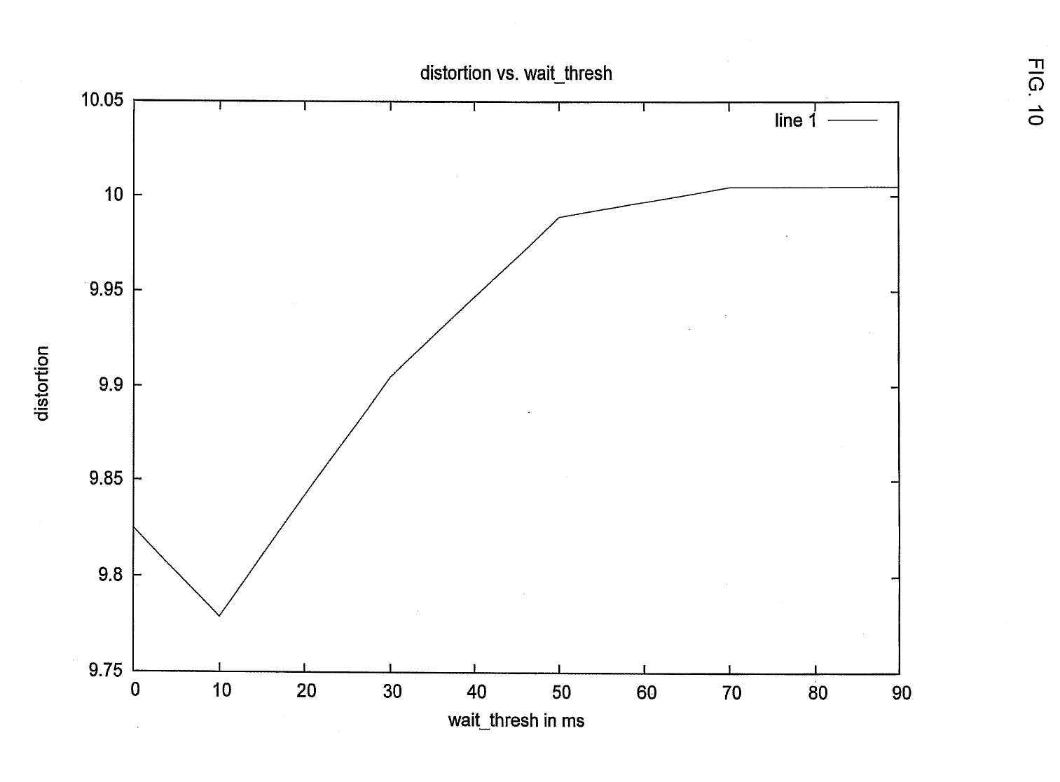

FIG. 10 is a diagram exemplifying a relationship between the threshold value used for the transmission control for the position prediction information item y[m] illustrated in FIG. 9 and a distortion (here, difference between an actual position and a predicted position).

The abscissa represents the threshold value Δ in milliseconds, while the ordinate is a relative value of a magnitude of the distortion with respect to a certain reference value.

The distortion, to be more specifically expressed, is a mean value of differences between an actual avatar position on the transmitting side and the position of the avatar which is acquired on the received side by receiving the position update information item within the waiting time threshold value or which is reconstructed/estimated on the receiving side by using the position prediction information item y[m] (EPP). It should be noted that the avatar exists not in the physical world but in the virtual world such as a game, and hence the position thereof is not normally expressed in the physical unit of meters or the like.

Therefore, the ordinate is not assigned the unit of length also in FIG. 10.

Note that the above-mentioned relationship is determined based on a configuration of the network 100, a delay, a packet loss factor, and the like.

A graph of FIG. 10 is obtained empirically, and produces the best result when Δ=10 ms.

Note that conditions for an experiment for obtaining the graph are indicated as in the following items (1) to (4).

(1) In order to test effectiveness of the position prediction information item y[m] in an actual online game, update information items for games, which are necessary to play popular first person shooting game (FPS) “bzflag[1] ” and “sauerbraten[2] ” for 10 minutes were collected.

Two clients actively participated in the FPS via a LAN that is low in loss and low in delay.

When the periodic position update information item x[n] from client2 reached client1, a filter was used to acquire the update information item for the game.

(2) A simulation of a network was performed by using a network simulator developed in advance with respect to a given acquired update information item for the game.

For a delay in the network, an independent and identically distributed (iid) delay model was used.

Each packet was given a network delay with a shifted-Gamma distribution iid perimeter of (κ, α, λ)=(40 ms, 3, 0.1).

As a result, a mean transmission delay became 70 ms.

With regard to a network loss, the following two loss models were used:

(i) An iid loss model exhibiting a loss factor of 0.1; and

(ii) A Markov loss model (Gilbert model) exhibiting two states of a loss factor of 0.1 and a burst loss length of 2.22.

(3) For the update information for the game, x and y of the avatar in the virtual world were transmitted from a transmitter to a recipient every 100 ms, each update information item was assumed to be 90 bytes, a change in end-to-end bandwidth was assumed to be 12 kbps to 15 kbps, and a bandwidth remaining after steady-state transmission of the position update information item x[n] was used for the position prediction information item y[m].

(4) On a receiving side, the dead-reckoning unit 310 projects the current position of the avatar.

A Euclidean distance between a position projected on a transmitting side and an actual position on the transmitting side serves as a scale for evaluation.

The transmission unit 210 stores the position update information item x[n] input from the avatar position processing unit 202 in a packet, and transmits the packet to the game client computer 3 via the network 100 according to a UDP.

The transmission unit 210 stores the position prediction information item y[m] input from the position prediction information formation unit 208 in a packet, and according to the above-mentioned control performed by the token control unit 212 and the delay control unit 214, transmits the packet to the game client computer 3 via the network 100 according to the UDP.

[Client Software 30]

In the client software 30, the reception unit 304 receives a series of position update information items x′[n] and position prediction information items y′[m] which are transmitted from the game server 2 via the network 100 and in which a delay and a packet loss have occurred.

As illustrated in FIG. 9, the position update information item x[n] is transmitted from the game server 2 to the game client computer 3 at intervals of T (seconds).

After reception of the position update information item x′[n], the delay control unit 302 waits a waiting time threshold value δ for the subsequent position update information item x′[n+1].

However, in a case where it becomes possible to accurately reconstruct the subsequent position update information item x′[n+1], which has not been received yet, by using the series of position update information items and position prediction information items that have been received so far, the reconstruction/estimation unit 306 may be urged to obtain the subsequent position update information item x′[n+1] without waiting for the reception of the subsequent position update information item x′[n+1].

In a case where the item x′[n+1] cannot be received even if the waiting time threshold value δ has been waited, in order that the position prediction information item y′[m] that has already been received and a past position update information item be used to make it possible to reconstruct/estimate the subsequent position, the reconstruction/estimation unit 306 is notified that the subsequent position update information item x′[n+1] could not be received within the period of time.

The reason why the above-mentioned branching is performed between the case of using the subsequent position update information item and the case of performing reconstruction/estimation after judging that the subsequent position update information item has been lost on the network depending on the waiting time after the reception of the last position update information item is as follows.

In a case where a waiting time v from reception of the last position update information item x′[1] until reception of the subsequent position update information item x′[2] may be set larger than T, even if a series of position update information items received until that time point and v become larger than T (that is, even if a time point at which the item x′[2] should have been received has been passed as long as there occurs no packet delay), a permissible period of time (for example, approximately 2T) may be waited instead of immediately judging that there occurs a packet loss.

In a case where the subsequent position update information item x′[2] is received during the waiting time for waiting longer than T as described above, there is an advantage in that a “true” value having no error can be obtained instead of using a predicted value.

However, if the waiting time becomes too long, a difference between the updated position at a time of reception on the receiving side (which was correct a while ago) and the current position on the transmitting side becomes large.

Therefore, there exists such a waiting time threshold value for the above-mentioned branching that the subsequent position update information item must be no longer waited for.

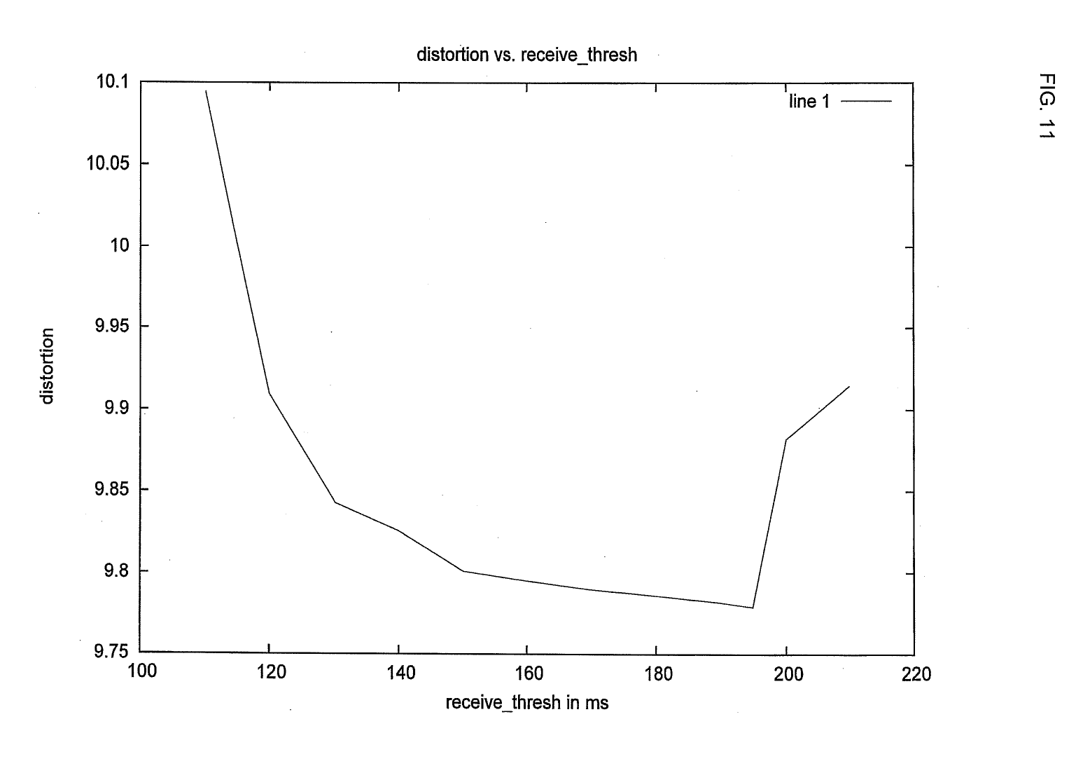

FIG. 11 is a diagram exemplifying the above-mentioned relationship between the waiting time threshold value δ and the distortion (here, difference between the actual position and the predicted position).

The abscissa represents the waiting time threshold value δ in milliseconds, while the ordinate is a relative value of a magnitude of the distortion with respect to a certain reference value.

The distortion, to be more specifically expressed, is a mean value of differences between an actual avatar position on the transmitting side and the position of the avatar which is acquired on the received side by receiving the position update information item within the waiting time threshold value or which is reconstructed/estimated on the receiving side by using the position prediction information item y[m] (EPP). It should be noted that, as described with reference to FIG. 10, the avatar exists not in the physical world but in the virtual world such as a game, and hence the avatar position is not normally expressed in the physical unit, and therefore the ordinate is not assigned the unit of length also in FIG. 11.

The above-mentioned relationship is determined based on the configuration of the network 100, the delay, the packet loss factor, and the like.

A graph of FIG. 11 is obtained empirically, and employs the same conditions as in the case of FIG. 10.

In the example of FIG. 11, by setting the waiting time threshold value δ=195 ms, it was made possible to reduce the difference between the actual position and the predicted position to a minimum.

The reconstruction/estimation unit 306 uses the position update information item x′[n] and the position prediction information item y′[m] that have been input from the reception unit 304 to perform reconstruction and estimation of data as illustrated in FIG. 6, obtains a position information item z[n] of each avatar to be displayed on the input/output device 126 (FIG. 2) of the game client computer 3 at each time point, and outputs the position information item z[n] to the dead-reckoning processing software 310.

The dead-reckoning processing software 310 performs correction of a delay time γₙ in the network 100 with respect to the position information item z[n], and outputs the resultant as a position information item x″[n+γₙ] to the client-side game software 312.

The client-side game software 312 uses the input position information item “[n+γₙ] to display the avatar of each player on the input/output device 126.

[Entire Operation of Network Game System 1]

Hereinafter, description is made of an entire operation of the network game system 1 illustrated in FIG. 1.

On the game server 2 side, the server-side game software 200 (FIG. 3) causes the network game to make progress according to the operation performed by the player of the game client computer 3, and the avatar position processing unit 202 forms the position update information item x[n] that indicates the position of each user's avatar in the virtual space of the network game.

As described with reference to FIG. 5, the position prediction information formation unit 208 forms the position prediction information item y[m] based on the position update information item x[n].

As described with reference to FIG. 8, the token control unit 212 controls the transmission unit 210 to perform the transmission control of the position prediction information item y[m] based on the token bucket scheme.

As described with reference to FIGS. 9 and 10, after the transmission of the position update information item x[n], the delay control unit 214 compares the period of time u until the token control unit 212 judges that the position prediction information item y[n₊1] is transmittable with the threshold value Δ, and if the period of time u is smaller than the threshold value Δ, transmits the formed position prediction information item y[n+1]. If the period of time u is equal to or larger than the threshold value Δ, the delay control unit 214 controls the transmission unit 210 so as to wait until the timing for the subsequent transmission of the position update information item x[n+1] before transmitting the position update information item x[n+1] and then transmitting the position prediction information item y[n+2] at the subsequent time point.

The transmission unit 210 stores the position update information item x[n] and the position prediction information item y[m] in the packet, and transmits the packet to the game client computer 3 according to the control performed by the token control unit 212 and the delay control unit 214.

On the game client computer 3 side, the reception unit 304 (FIG. 3) receives the position update information item x′[n] and position prediction information item y′[m] which have been transmitted from the game server 2 via the network 100.

As described with reference to FIGS. 9 and 11, after the reception of the position update information item x′[n], the delay control unit 302 waits for the reception of the subsequent position update information item x′[n+1] until the elapse of the waiting time threshold value δ, and in the case where the position update information item x′[n+1] could not be received even if a period of time corresponding to the waiting time threshold value δ has elapsed, controls the reconstruction/estimation unit 306 so as to perform the reconstruction/estimation after judging that a loss of the information has occurred.

Further, in the case where the reception unit 304 received the subsequent position update information item x′[n₊1] within the waiting time threshold value δ, the delay control unit 302 controls the reception unit 304 so as to output the received information item to the reconstruction/estimation unit 306.

As described with reference to FIG. 6, the reconstruction/estimation unit 306 uses the position update information item x′[n] and the position prediction information item y′[m] that have been input from the reception unit 304 to perform the reconstruction and estimation of the data, and outputs the resultant as the position information item z[n].

The dead-reckoning processing software 310 performs the correction of the delay time γₙ in the network 100 with respect to the position information item z[n], and outputs the resultant as the position information item x″[n_{+γ}ₙ].

The client-side game software 312 uses the input position information item “[n+γₙ] to display the avatar of each player on the input/output device 126.

### DESCRIPTION OF SYMBOLS

1 . . . network game system
100 . . . network

2 . . . game server
120 . . . system core
122 . . . CPU
124 . . . memory
126 . . . input/output device
128 . . . transmission device
132 . . . storage device
134 . . . storage medium

20 . . . server software
200 . . . server-side game software
202 . . . avatar position processing unit
204 . . . server-side interface software
208 . . . position prediction information formation unit
210 . . . transmission unit
212 . . . token control unit
214 . . . delay control unit

3 . . . game client computer
30 . . . client software
   300 . . . client-side interface software
   302 . . . delay control unit
   304 . . . reception unit
   310 . . . dead-reckoning processing software
   312 client-side game software

### INDUSTRIAL APPLICABILITY

The present invention can be used for transmitting data such as data of the network game, in which the real-time property is regarded as being important, via the network in which a delay, a loss of packet, and the like occur.

1. A data transmission system for transmitting transmission data generated in each of predetermined cycles and prediction data for predicting transmission data in a cycle subsequent thereto based on one or more items of the transmission data from a transmission device to a reception device via a network, the network causing a delay and a loss with respect to the transmission data,
the transmission device comprising:
transmission data generation means for generating the transmission data;
prediction data generation means for generating the prediction data; and
transmission means for transmitting the generated transmission data and transmitting the generated prediction data by using a bandwidth of a difference between a bandwidth allocated on the network and a bandwidth of the transmission data,
the reception device comprising:
reception means for receiving the transmission data and the prediction data that have been transmitted; and
reconstruction/estimation means for reconstructing or estimating, when the transmission data is lost, the lost transmission data by using the transmission data and the prediction data that have been received.

2. A data transmission system according to claim 1, wherein the reception device further comprises a delay compensation means for compensating for the delay that has occurred in the transmission data in the network.

3. A data transmission system according to claim 1, wherein:
the transmission device further comprises transmittability judgment means for judging whether or not the prediction data is transmittable based on the difference between the bandwidth allocated on the network and the bandwidth of the transmission data and the bandwidth necessary for transmitting the generated prediction data; and
the transmission means transmits the prediction data if the prediction data is judged to be transmittable.

4. A data transmission system according to claim 3, wherein the transmittability judgment means judges whether or not the prediction data is transmittable based on a token bucket scheme so as to prevent, even if the prediction data is transmitted, the bandwidth of the transmitted prediction data from exceeding the difference between the bandwidth allocated on the network and the bandwidth of the transmission data.

5. A data transmission system according to claim 3, wherein:
the transmission device further comprises transmission time judgment means for judging whether or not a time difference from transmission of the transmission data until transmission of the prediction data used for prediction using the transmission data is shorter than a predetermined threshold value; and
the transmission means transmits the prediction data if the time difference until the transmission of the prediction data is shorter than the predetermined threshold value.

6. A data transmission system according to claim 1, wherein:
the reception device further comprises reception time judgment means for judging whether or not the transmission data in the subsequent cycle has been received by a time difference within a predetermined threshold value from reception of the transmission data; and
the estimation means estimates transmission data subsequent to the received transmission data if the transmission data in the subsequent cycle has not been received by the time difference within the predetermined threshold value.

7. A data transmission system according to claim 1, wherein the reception device further comprises forecast means for forecasting transmission data to be received in a future based on the received transmission data and the estimated transmission data or any one thereof.

8. A data transmission system according to claim 1, wherein the transmission data indicates a position of a moving object in the each of the predetermined cycles.

9. A data transmission system according to claim 1, wherein the transmission data indicates, in a network game performed by moving one or more avatars, a position of each of the one or more avatars in the each of the predetermined cycles.

10. A data transmission method of transmitting transmission data generated in each of predetermined cycles and prediction data for predicting transmission data in a cycle subsequent thereto based on one or more items of the transmission data from a transmission device to a reception device via a network, the network causing a delay and a loss with respect to the transmission data,
the data transmission method comprising:
by the transmission device:
generating the transmission data;
generating the prediction data; and
transmitting the generated transmission data and transmitting the generated prediction data by using a bandwidth of a difference between a bandwidth allocated on the network and a bandwidth of the transmission data; and
by the reception device:
receiving the transmission data and the prediction data that have been transmitted; and
reconstructing or estimating, when the transmission data is lost, the lost transmission data by using the transmission data and the prediction data that have been received.

11. A data transmission program for transmitting transmission data generated in each of predetermined cycles and prediction data for predicting transmission data in a cycle subsequent thereto based on one or more items of the transmission data from a transmission device to a reception device via a network, the network causing a delay and a loss with respect to the transmission data,
the data transmission program causing a computer to execute, in the transmission device:
a transmission data generation step of generating the transmission data;
a prediction data generation step of generating the prediction data; and
a transmission step of transmitting the generated transmission data and transmitting the generated prediction data by using a bandwidth of a difference between a bandwidth allocated on the network and a bandwidth of the transmission data,
the data transmission program further causing the computer to execute, in the reception device:
a reception step of receiving the transmission data and the prediction data that have been transmitted; and
a reconstruction/estimation step of reconstructing or estimating, when the transmission data is lost, the lost transmission data by using the transmission data and the prediction data that have been received.
